(19) United States
(12) Patent Application Publication
(10) Pub. No.: US 2025/0087672 A1
(43) Pub. Date: Mar. 13, 2025

(54) ALLOY COATING ON LITHIUM METAL ANODES WITH NITROGEN-RICH SOLID ELECTROLYTE INTERPHASE

(71) Applicant: GM GLOBAL TECHNOLOGY OPERATIONS LLC, Detroit, MI (US)

(72) Inventors: Sayed Youssef Sayed NAGY, Troy, MI (US); Caleb Reese, Ferndale, MI (US); Diptak Bhattacharya, Royal Oak, MI (US); Anil K. Sachdev, Rochester Hills, MI (US)

(21) Appl. No.: 18/464,854

(22) Filed: Sep. 11, 2023

(51) Int. Cl. H01M 4/36; H01M 4/04; H01M 4/134; H01M 4/136; H01M 4/38; H01M 4/40; H01M 4/58; H01M 4/66; H01M 10/0585

(52) U.S. Cl. CPC H01M 4/366; H01M 4/0404; H01M 4/134; H01M 4/136; H01M 4/382; H01M 4/405; H01M 4/5825; H01M 4/661; H01M 4/669; H01M 10/0585; H01M 2004/027

(57) ABSTRACT

A battery cell includes a battery cell stack including A anode electrodes including an anode active material layer arranged adjacent to an anode current collector; C cathode electrodes including a cathode active material layer arranged adjacent to a cathode current collector; and S separators arranged between the A anode electrodes and the C cathode electrodes. The anode active material layer of the A anode electrodes includes a lithium metal layer and a lithium alloy layer comprising an alloy of lithium and a lithiophilic metal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to lithium metal anode (LMA) electrodes for battery cells.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving. Manufacturers of EVs are pursuing increased power density to increase the range of the EVs.

### SUMMARY

A battery cell includes a battery cell stack including A anode electrodes including an anode active material layer arranged adjacent to an anode current collector; C cathode electrodes including a cathode active material layer arranged adjacent to a cathode current collector; and S separators arranged between the A anode electrodes and the C cathode electrodes. The anode active material layer of the A anode electrodes includes a lithium metal layer and a lithium alloy layer comprising an alloy of lithium and a lithiophilic metal.

In other features, the lithiophilic metal is selected from a group consisting of zinc, indium, tin, aluminum, silver, and gallium. A lithium nitrate layer is arranged on the lithium alloy layer. An enclosure surrounds the battery cell stack and a liquid electrolyte is arranged in the enclosure.

In other features, the battery cell stack includes a solid-state electrolyte. The lithium metal layer is arranged on opposite sides of the anode current collector. The anode current collector is made of a material selected from a group consisting of copper, stainless steel, and nickel. The anode current collector and the lithium metal layer comprise laminated foil.

A method for manufacturing a battery cell includes providing a lithium metal anode electrode including first and second lithium metal layers arranged on opposite sides of an anode current collector; and immersing the first and second lithium metal layers and the anode current collector in a bath including a metal salt solution comprising a lithiophilic metal and a nitrate salt. The lithium metal anode electrode is coated with a lithium alloy layer and a lithium nitrate layer.

In other features, the method includes selecting the lithiophilic metal from a group consisting of zinc, indium, tin, aluminum, silver, and gallium. The method includes creating a battery cell stack including A of the lithium metal anode electrode; C cathode electrodes including a cathode active material layer arranged adjacent to a cathode current collector; and S separators arranged between the A anode electrodes and the C cathode electrodes.

In other features, the method includes removing the lithium nitrate layer. The method includes using a solid-state electrolyte.

In other features, the method includes arranging the battery cell stack in an enclosure and using a liquid electrolyte. The anode current collector is made of a material selected from a group consisting of copper, stainless steel, and nickel. The anode current collector and the first and second lithium metal layers comprise laminated foil.

A method for manufacturing a battery cell includes providing a lithium metal anode electrode including a laminated foil including first and second lithium metal layers arranged on opposite sides of an anode current collector; and immersing the laminated foil in a bath including a metal salt solution comprising a lithiophilic metal and a nitrate salt for a predetermined period. The lithiophilic metal is selected from a group consisting of zinc, indium, tin, aluminum, silver, and gallium. Outer surfaces of the first and second lithium metal layers of the laminated foil are coated with a lithium-metal alloy layer and a lithium nitrate layer.

In other features, the method includes creating a battery cell stack including A of the lithium metal anode electrode; C cathode electrodes including a cathode active material layer arranged adjacent to a cathode current collector; and S separators arranged between the A anode electrodes and the C cathode electrodes.

In other features, the method includes removing the lithium nitrate layer and using a solid-state electrolyte.

In other features, the method includes arranging the battery cell stack in an enclosure and using a liquid electrolyte.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell including lithium metal anode (LMA) electrodes with lithium-metal alloy coatings according to the present disclosure;

FIG. 2 is a side cross sectional view an example of a plurality of battery cells arranged in an enclosure of a battery pack;

FIGS. 3 and 4 illustrate an example of coating of a LMA electrode with a lithium metal layer and a lithium nitrate layer according to the present disclosure;

FIG. 5 is a flowchart of an example of a method for manufacturing battery cells by coating a LMA electrode and combining the anode electrode with cathode electrodes and separators to form a battery cell according to the present disclosure; and

FIG. 6 illustrates an example of electrochemical deposition of the lithium alloy layer onto the LMA electrode.

In the drawings, reference numbers may be reused to identify similar and/or identical elements.

### DETAILED DESCRIPTION

While battery cells with lithium metal anode (LMA) electrodes including a lithium-metal alloy coating according to the present disclosure are described in conjunction with electric vehicles, the battery cells lithium metal anode (LMA) electrodes including a lithium-metal alloy coating can be used in other applications.

Corrosion of lithium metal in LMA electrodes may occur in battery cells. When corrosion occurs, the corrosion consumes lithium and/or electrolyte and causes capacity degradation of the lithium metal battery (LMB). Lithium also has poor wettability with most solid state electrolytes (SSEs).

The present disclosure relates to modification of a surface of lithium metal anode (LMA) electrodes with a lithium-metal alloy to mitigate lithium dendrite growth and minimize corrosion of the lithium of the LMA The coating also improves the wettability of the plated lithium during charging.

In some examples, the LMA electrode is immersed in a metal salt including lithiophilic metal ions M⁺. Lithium-metal (lithium-M) alloy forms on a surface of the LMA electrode. When using nitrate salts of the lithiophilic metal species of interest, the lithium surface is also coated with lithium nitrate (LiNO₃). For applications using liquid electrolyte, the LiNO₃ layer increases a solid electrolyte interphase (SEI) for nitrogen-based electrolyte species of high ionic conductivity for lithium, such as Li₃N. For applications using solid-state electrolyte (SSE), the lithium nitrate (LiNO₃) can be rinsed/removed using an ether-based electrolyte or other suitable electrolyte.

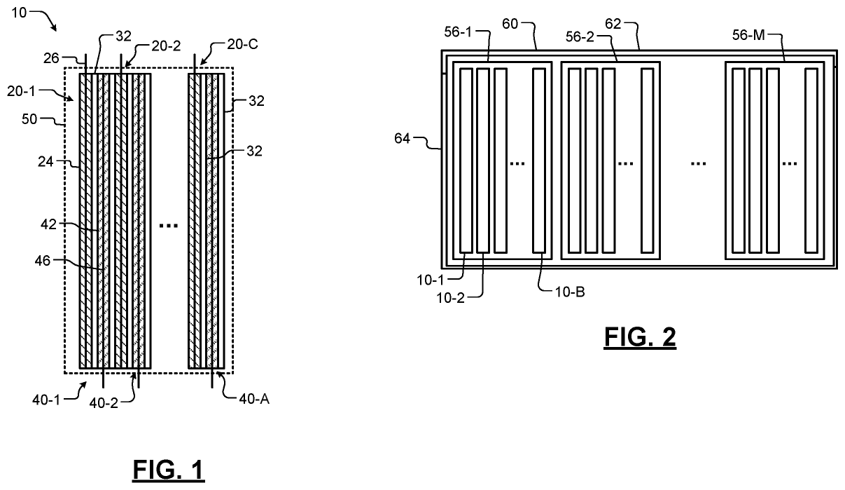

Referring now to FIGS. 1 and 2, a battery cell 10 includes cathode electrodes 20-1, 20-2, . . . , and 20-C, where C is an integer greater than one. The cathode electrodes 20 include a cathode active material layer 24 arranged on one or both sides of cathode current collectors 26. The battery cell 10 includes anode electrodes 40-1, 40-2, . . . , and 40-A, where A is an integer greater than one. The anode electrodes 40 include an anode active material layer 42 including lithium metal arranged on one or both sides of anode current collectors 46. The cathode electrodes 20, the anode electrodes 40, and the separators 32 are arranged in a predetermined order in an enclosure 50. For example, separators 32 are arranged between the cathode electrodes 20 and the anode electrodes 40.

In FIG. 2, a battery pack 58 includes M battery modules 56-1, 56-2, . . . , and 56-M each including B of the battery cells 10 (e.g., battery cells 10-1, 10-2, . . . , and 10-B), where B and M are integers greater than one. The enclosure 60 includes a cover 62 and a lower portion or tray 64.

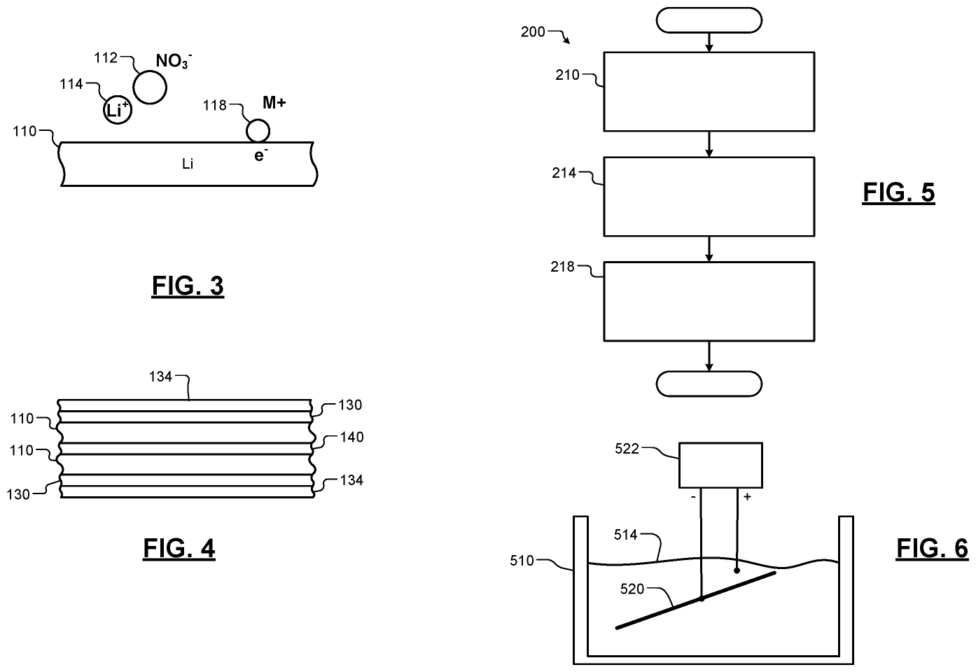

Referring now to FIGS. 3 and 4, a lithium metal anode layer 110 is immersed in a salt solution including metal ions (M⁺) 118 and nitrate salt (NO₃) 112. A lithium metal (lithium-M) alloy layer 130 is formed on the surface of the lithium metal anode layer 110 via electrochemical deposition. A lithium nitrate layer 134 is also formed on the lithium-M alloy layer 130.

In some examples, the lithium metal anode layer 110 is arranged on both sides of an anode current collector 140 and plating is performed on outer exposed surfaces of the lithium metal anode layers 110. In some examples, the lithium-M alloy layer 130 has a thickness in a range from 20 nm to 100 nm. In some examples, the thickness of the lithium-M alloy layer 130 depends upon an electrochemical deposition period and a concentration of the metal ions in the metal salt. In some examples, the lithium metal anode layer(s) 110 and the current collector comprise laminated foil. In some examples, the anode current collector is made of a material selected from a group consisting of copper, stainless steel, or nickel.

When the LMA is immersed in the metal salt, a spontaneous galvanic displacement process occurs between a surface of the LMA and lithiophilic metal ions M⁺. In some examples, the metal ions M⁺ include ions of zinc (Zn²⁺), indium (In³⁺), tin (Sn²⁺), aluminum (Al³⁺), silver Ag⁺, gallium Ga³⁺, and/or other suitable lithiophilic metal ions. lithium has very low redox potential (−3.04V vs normal hydrogen electrodes) and undergoes oxidation, which releases electrons e-to reduce the metal ions on the lithium surface when placed in a salt solution of the metal (M) ions of interest.

The reduced metal reacts with the lithium surface to form lithium-metal (lithium-M) alloys. When using nitrate salts of the lithiophilic elements of interest, the lithium surface is enriched with lithium nitrate (LiNO₃). The LiNO₃ increases a solid electrolyte interphase (SEI) with nitrogen-based electrolyte species of high ionic conductivity for lithium, such as Li₃N. This will cause deposition of planar lithium and increase the cycle life of the lithium metal batteries (LMB). The following reactions summarize the galvanic displacement process:

$$\begin{matrix}x Li + M ( {NO}_{3} ) x = M + {x LiNO}_{3} \\ y Li + zM = {Li}_{y} {M}_{z}\end{matrix}$$

Referring now to FIG. 5, a method for manufacturing battery cells including metal-coated lithium metal anodes is shown. At 210, a lithium metal anode is immersed in a metal salt solution including metal ions M⁺ to create a lithium metal (LiM) alloy layer on the lithium metal anode and a lithium nitrate (LiNO₃) layer on the LiM alloy layer.

At 214, the surface is optionally rinsed with an ether-based electrolyte to remove the surface LiNO₃ layer for applications using solid-state electrolyte with high wettability to LMAs. In some examples, the surface LiNO₃ layer is not rinsed/removed for applications using liquid electrolytes (e.g., the surface LiNO₃ layer provides a nitrogen-rich SEI). At 218, battery cells are manufactured using the lithium metal anodes, cathode electrodes and separators.

Referring now to FIG. 6, an example of a method for coating a lithium metal anode electrode 520 is shown. The lithium metal anode electrode 520 is immersed in a bath 510 including a metal salt 514 including lithiophilic metal ions for a predetermined period. A power source 522 is connected to the lithium metal anode electrode 520 and the metal salt 514 or an enclosure of the bath 510 (if conductive). A spontaneous galvanic displacement process occurs between a surface of the LMA and lithiophilic metal ions M⁺. In some examples, the metal ions M⁺ include ions of zinc (Zn²⁺), indium (In³⁺), tin (Sn²⁺), aluminum (Al³⁺), silver Ag⁺, gallium Ga³⁺, and/or other suitable metal ions.

The present disclosure provides a low-cost approach for coating a surface of the LMA with a thin layer of lithium-metal alloy of a lithiophilic metal to mitigate lithium dendrite growth and increase the wettability and particle size of the plated lithium. The lithium-M alloy layer acts as a protective coating to minimize galvanic corrosion of the LMA. The method also enriches the SEI layer with a nitrogen-based species to provide homogenous lithium ion flux through the SEI and increase the size of the plated lithium during charging. The method also improves wettability of the lithium anodes with SSEs.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
a battery cell stack including:
A anode electrodes including an anode active material layer arranged adjacent to an anode current collector;
C cathode electrodes including a cathode active material layer arranged adjacent to a cathode current collector; and
S separators arranged between the A anode electrodes and the C cathode electrodes,
wherein the anode active material layer of the A anode electrodes includes:
a lithium metal layer; and
a lithium alloy layer comprising an alloy of lithium and a lithiophilic metal.

2. The battery cell of claim 1, wherein the lithiophilic metal is selected from a group consisting of zinc, indium, tin, aluminum, silver, and gallium.

3. The battery cell of claim 1, further comprising a lithium nitrate layer arranged on the lithium alloy layer.

4. The battery cell of claim 2, further comprising:
an enclosure surrounding the battery cell stack; and
a liquid electrolyte in the enclosure.

5. The battery cell of claim 1, wherein the battery cell stack further comprises a solid-state electrolyte.

6. The battery cell of claim 1, wherein the lithium metal layer is arranged on opposite sides of the anode current collector.

7. The battery cell of claim 6, wherein the anode current collector is made of a material selected from a group consisting of copper, stainless steel, and nickel.

8. The battery cell of claim 6, wherein the anode current collector and the lithium metal layer comprise laminated foil.

9. A method for manufacturing a battery cell, comprising:
providing a lithium metal anode electrode including first and second lithium metal layers arranged on opposite sides of an anode current collector; and
immersing the first and second lithium metal layers and the anode current collector in a bath including a metal salt solution comprising a lithiophilic metal and a nitrate salt,
wherein the lithium metal anode electrode is coated with a lithium alloy layer and a lithium nitrate layer.

10. The method of claim 9, further comprising selecting the lithiophilic metal from a group consisting of zinc, indium, tin, aluminum, silver, and gallium.

11. The method of claim 10, further comprising creating a battery cell stack including:
A of the lithium metal anode electrode;
C cathode electrodes including a cathode active material layer arranged adjacent to a cathode current collector; and
S separators arranged between the A anode electrodes and the C cathode electrodes.

12. The method of claim 10, further comprising removing the lithium nitrate layer.

13. The method of claim 12, wherein the battery cell stack includes a solid-state electrolyte.

14. The method of claim 11, further comprising arranging the battery cell stack in an enclosure and using a liquid electrolyte.

15. The method of claim 9, wherein the anode current collector is made of a material selected from a group consisting of copper, stainless steel, and nickel.

16. The method of claim 15, wherein the anode current collector and the first and second lithium metal layers comprise laminated foil.

17. A method for manufacturing a battery cell, comprising:
providing a lithium metal anode electrode including a laminated foil including first and second lithium metal layers arranged on opposite sides of an anode current collector; and
immersing the laminated foil in a bath including a metal salt solution comprising a lithiophilic metal and a nitrate salt for a predetermined period,
wherein the lithiophilic metal is selected from a group consisting of zinc, indium, tin, aluminum, silver, and gallium, and
wherein outer surfaces of the first and second lithium metal layers of the laminated foil are coated with a lithium-metal alloy layer and a lithium nitrate layer.

18. The method of claim 17, further comprising creating a battery cell stack including:
A of the lithium metal anode electrode;
C cathode electrodes including a cathode active material layer arranged adjacent to a cathode current collector; and
S separators arranged between the A anode electrodes and the C cathode electrodes.

19. The method of claim 17, further comprising:
removing the lithium nitrate layer; and
using a solid-state electrolyte.

20. The method of claim 18, further comprising arranging the battery cell stack in an enclosure and using a liquid electrolyte.
